(19) United States
(12) Patent Application Publication
(10) Pub. No.: US 2017/0203200 A1
(43) Pub. Date: Jul. 20, 2017

(54) BACCARAT PROGRESSIVE SYSTEM

(71) Applicant: Jamie Abrahamson, Las Vegas, NV (US)

(72) Inventor: Jamie Abrahamson, Las Vegas, NV (US)

(21) Appl. No.: 15/405,317

(22) Filed: Jan. 13, 2017

Related U.S. Application Data
(63) Continuation-in-part of application No. 15/157,518, filed on May 18, 2016.
(60) Provisional application No. 62/280,115, filed on Jan. 18, 2016.

(51) Int. Cl. A63F 1/00; G07C 15/00; G07F 17/32

(52) U.S. Cl. CPC A63F 1/00; G07F 17/3288; G07F 17/3293; G07F 17/3258; G07F 17/322; G07F 17/3218; G07F 17/3276; G07C 15/006; A63F 2001/001

(57) ABSTRACT

A system enables a method of executing a game of baccarat with a side bet event. The system includes a gaming table with at least two distinct player positions. The gaming table having positions thereon for placing an initial wager on the game of baccarat and for placing a second wager on the side bet event from at least one of at least two player positions at the gaming table on the game of baccarat, the side bet resolved by final playing cards at the player hand position and the banker hand position. Each of the at least two player positions has a secondary random outcome indicator display or non-random outcome indicator display. The gaming table provides to the secondary random or non-random outcome indicator displays at each player position and each distinct event outcome indicator represents a single digit number value.

### RELATED APPLICATION DATA

This application claims priority under 37 CFR 1.120 as a continuation-in-part application of U.S. Ser. No. 15/157,518, filed 18 May 2016 and titled BACCARAT PROGRESSIVE SYSTEM, which in turn claims priority from U.S. Provisional Patent Application Ser. No. 62/280,115, filed 18 Jan. 2016, and Titled BACCARAT PROGRESSIVE SYSTEM, which application is incorporate herein by reference in its entirety.

### BACKGROUND OF THE INVENTION

1. Field of the Invention

The present invention relates to the field of wagering events, wagering events involving the wagering event of baccarat, and especially jackpot events used in combination with baccarat.

2. Background of the Art

Baccarat is one of the many live table games played in casinos or gaming establishments. Baccarat uses a standard deck of 52 playing cards and is usually dealt from a shoe having multiple decks that have been shuffled together prior to the beginning of play.

The object of the game of Baccarat is for the better to successfully wager on whether the Banker's hand or the Player's hand is going to win. The bettor receives even money for his wager if he selects the winning hand and loses his wager if he selects the losing hand. Because of the rules of play of Baccarat and more particularly the pre-established draw rules, the Banker's hand has a slightly higher chance of winning than does the Player's hand. The winning frequency for the Banker's hand has been determined to be 0.45859 (45.859%) whereas the winning frequency for the Player hand is 0.44624 (44.624%) with the remainder of the outcomes being ties. Therefore, if the bettor wagers on the Banker's hand and the Banker hand wins, the bettor must pay to the gaming establishment a commission (typically, 5%) of the amount the bettor wins. No commission is paid if the bettor successfully wagers on the Player's hand.

As used in this specification, the term “Conventional Manner of Play of Baccarat” is as follows:

A multiple number of decks of standard playing cards, 52 in number, are used; typically eight decks are shuffled together and placed in a shoe from which the cards are dealt during the play of the game.

Each bettor makes a wager on whether the Banker's hand or the Player's hand will win. After all wagers are made, two cards are dealt from the shoe to the Banker position and two cards are dealt from the shoe to the Player position on the table layout. The cards are turned face up and the value of the Banker hand and the Player hand is determined, modulo ten.

Aces count one; Kings, Queens, Jacks and Tens count zero and the other cards count their respective face value. The suits (Spades, Hearts, Diamonds and Clubs) have no meaning in Baccarat.

The highest hand value in Baccarat is nine. All hand values range from a low of zero to a high of nine. If when the cards are added together, the total of the hand exceeds nine, then the hand value is determined modulo ten. For example, a seven and an eight total fifteen, but the hand value is five. An Ace and a nine total ten, but the hand value is zero.

A two card total of eight or nine is called a “natural”; a two card total of zero is called a “baccarat.” As will be explained below, in certain situations in the play of the game, a third card will be dealt. The value of this third card is added to the total of the first two cards and a new hand value is established. Again, if the new hand total exceeds nine, the hand value is determined by subtracting ten from the total of the hand.

Prior to the deal, each bettor can make one of three wagers: 1) that the Banker hand will win; 2) that the Player hand will win; or 3) that the Banker hand and the Player hand will tie. Wagering locations are provided on the Baccarat table layout. Whichever of the Banker hand or the Player hand is closest to a total on nine is the winner.

All winning Banker hand wagers are paid off at odds of one-to-one and the house charges a five percent (5%) commission on the amount won by the bettor. For example, if a bettor wagers $100 on the Banker hand and the Banker hand wins, the bettor wins $100 and is charged a $5 commission on the amount that the bettor won. The bettor is not charged any commission on the amount of his wager.

All winning Player hand wagers are paid off at odds of one-to-one and the bettor is not charged any commission on the amount of his winnings or his wager because the house, by virtue of the third card draw rules, has a statistical advantage over the player of 45.859-44.624 or 1.235% which is the vigorish (“vig”) of the house on player wagers. Winning wagers on the Tie hand bet are paid off at odds of nine-to-one or eight-to-one (depending on the gaming establishment) and the bettor is not charged any commission on the amount of his winnings or his wager since there is already a statistical advantage in favor of the house on tie wagers. If a Tie hand occurs, all wagers on the Banker hand and all wagers on the Player hand are “pushes” and the amount wagered is returned to the bettor.

Depending on the point total of the Player's hand and the Banker's hand, one more card may be dealt to either the Player's hand, the Banker's hand or both. The rules for determining whether a third card is dealt are fixed rules, there is no discretion for either the Player's hand or the Banker's hand on whether a third card is dealt.

If either the Player hand or the Banker hand has a point total of eight or nine on the first two cards, no third card is dealt to either hand and the hand with the highest point total is the winner (or the hand is a Tie, as the case may be). If neither the Player hand nor the Banker hand has a point total of eight or nine, then there is a possibility of a third card draw.

The third card draw rules are as follows:

Rule #1: If the initial two card Player hand has a point total of 0, 1, 2, 3, 4 or 5, the Player hand draws a third card. If the initial two card Player hand has a point total of 6 or 7, the Player hand stands and does not receive a third card.

Rule #2: If the Player hand stands and does not draw a third card, then the Banker hand follows Rule #1. In other words, if the Player hand has a point total of 6 or 7, the Banker hand draws a third card on a point total of 0, 1, 2, 3, 4 or 5 and the Banker hand stands on a point total of 6 or 7.

Rule #3: If the Player hand draws a third card, the Banker hand must draw or stand as follows:

TABLE 1
BACCARAT
RULES
PLAYER

| HAVING TWO CARD | |
|---|---|
| TOTAL OF | |
| 1-2-3-4-5-10 | DRAWS A CARD |
| 6-7 | STANDS |
| 8-9 | TURNS CARDS OVER |

BANKER

| | DRAWS WHEN | DOES NOT DRAW |
|---|---|---|
| HAVING | GIVING OR | WHEN GIVING OR |
| TWO CARD | PLAYER'S THIRD | PLAYER'S THIRD |
| TOTAL OF | CARD DRAW IS AN | CARD DRAW IS AN |
| 0, 1, 2 | ALWAYS DRAWS | |
| 3 | 1-2-3-4-5-6-7-9-10 | 8 |
| 4 | 2-3-4-5-6-7 | 1-8-9-10 |
| 5 | 4-5-6-7 | 1-2-3-8-9-10 |
| 6 | 6-7 | 1-2-3-4-5-8-9-10 |

| | |
|---|---|
| 7 | STANDS |
| 8-9 | TURNS CARDS OVER |

At the end of each hand, winning wagers are paid and losing wagers are collected by the house. Any commission due to the house is marked in commission boxes in the center of the table. Gaming chips are used to represent the amount of money owed by each bettor to the house for the commissions. In order not to slow down the game, the commission is not actually collected from each bettor until the end of the round determined by all of the cards in the shoe being dealt down to the plastic cut card, usually approximately eighty hands.

The mathematical analysis of the game reveals that the 5% commission is what gives the house its advantage on wagers on the Banker hand and allows the gaming establishment to make a profit from providing the Baccarat game to the bettors. Because the rules for standing and drawing third cards are automatic, the mathematical analysis shows that the Banker hand will win 45.859% of the hands, the Player hand will win 44.624% of the hands and the Tie hand will occur 9.517% of the hands. If the Tie hands are disregarded because they do not affect any Player or Banker wagers, it is then determined that the Banker hand will win 50.7% of the time and the Player hand will win 49.3% of the time.

Because the Banker hand wins more than 50% of the hands (disregarding the Tie hands that do not affect any Player or Banker wagers), if a better always bet on the Banker hand, the bettor would have an advantage over the gaming establishment. By charging a 5% commission on all Banker hand wins, the gaming establishment compensates for the percentage of winning Banker hands being slightly over 50%.

After figuring in the 5% commission that must be paid by bettors on winning Banker hands, the gaming establishment has approximately a 1.23% advantage over the bettor when the bettor wagers on the Player hand and the gaming establishment has a 1.057% advantage over the bettor when the bettor wagers on the Banker hand. The Tie hand wager gives the gaming establishment a 4.88% advantage over the bettor when the payoff odds are nine-to-one and a 14.1% advantage over the bettor when the payoff odds are eight-to-one.

Because of the limited number of playing cards provided in baccarat, it has been difficult to design jackpots and progressive jackpots with a balance between sufficiently high hit frequency and sufficiently high jackpots that will maintain the interest of players.

U.S. Pat. No. 5,275,411 (Breeding) discloses a position of start indicator for Pai Gow poker games where a hand-position for first hands dealt is randomly indicated by a 7-segment display for positions 1-7. All references to Patent Documents made herein are incorporated by reference in their entirety.

### SUMMARY OF THE INVENTION

A system enables a method of executing a game of baccarat with a side bet event. The system includes a gaming table with at least two distinct player positions. The gaming table having positions thereon for placing an initial wager on the game of baccarat and for placing a second wager on the side bet event from at least one of at least two player positions at the gaming table on the game of baccarat, the side bet resolved by final playing cards at the player hand position and the banker hand position. Each of the at least two player positions has a secondary random outcome indicator display. The gaming table has a random event generator providing distinct random event outcome indicators to the secondary random outcome indicator displays at each player position and each distinct random event outcome indicator represents a single digit number value. The number at each player position may also be assigned by other than random events, such as various mechanisms for selection, auction or pre-assignment of different numbers at each player position.

### DETAILED DESCRIPTION OF THE INVENTION

A method executes a game of baccarat with a side bet event. The game of baccarat may be a standard or variant game of baccarat in which a player hand of playing cards is in competition with a banker hand of playing cards. A player hand position and a banker hand position receive playing cards from at least one randomized deck of 52 playing cards. The method may include: placing of an initial wager from at least one of at least two player positions at a gaming table on the game of baccarat;

the at least one player position placing a second wager on a side bet event resolved by using final playing cards dealt to the player hand position and final playing cards dealt to the banker hand position;

providing each of the at least two player positions with a secondary random outcome indicator display;

a random event generator providing distinct random event outcome indicators to the secondary random outcome indicator displays at each of the at least two player positions; The indicator displays may be any component or system that is visually (or even electronically) readable. This may include 7-segment displays, nine bulbs, an image panel (with LED, Liquid Crystal, plasma, analog or digital displays), or any other system. The nature of the image may be common Arabic numerals, Roman, numerals, numbers of dots or dashes, card symbols, animals, etc. Anything that indicates a single digit value in the display will suffice.

Each distinct random event outcome indicator represents a single digit number value selected from the group consisting of 0, 1, 2, 3, 4, 5, 6, 7, 8 and 9; It is possible to use fewer numbers so as to remove the impact of some ties (e.g., remove 0 as an indicator so that zero ties are never a Golden Tie. In doing so, a “blank” indicator may be provided to a player position in place of the 0 to assure that all available indicators matching the single digits are available.)

At the conclusion of providing the final hands of playing cards to the player hand position and the banker hand position:

resolving the initial wager according to standard rules of baccarat; and

resolving the second wager at the at least one player position as a highest winning outcome when a single digit point count according to rules of baccarat in the final banker hand equals a single digit point count according to rules of baccarat in the final player hand and the single digit number value at one of the at least two player positions represented by the distinct random event outcome indicator is also equal to the single digit point count according to rules of baccarat in the final player hand.

The random event outcome indicator comprises a random number generator or random event generator that provides equally weighted distinct indications on individual displays at each of the at least two player positions of single digit point counts selected from the group consisting of 0, 1, 2, 3, 4, 5, 6, 7, 8, and 9. The numbers may be randomly weighted also, so as to make ties in some numbers more valuable than ties in other numbers, such that a 0-Tie is low or no value, 9-Ties are next in value, 8-Ties highest values, and 1-, 2-, 3, 4-, 5-, 6- and 7-Ties have intermediate values. The random event generator may also be a combination of a template of total table displays and a random number generator, or may be a provided, ordered or unordered set of templates. For example, there could be many different available templates (e.g., 8 factorial times 10) for the distribution of the 10 possible tie outcomes at each player position. Each template within the total collection of templates would assign a specific tie-number value to each player position such that within the total of templates, all possible distributions of the tie-values are represented. The templates may be preordered (that is a memory may have the templates provided in an order of selection, even though the relations of successive templates are random, or a random number generator may select individual ones of the templates randomly. In any event, all of these technologies are included within the scope of the recitation of “a random event generator providing distinct random event outcome indicators to the secondary random outcome indicator displays at each of the at least two player positions . . . ”

Templates have been used in the art for provision of complete game outcomes, as shown in U.S. Pat. No. 6,159,096 (Yoseloff), but have not been used for technology such as the present invention where an actual outcome on the gaming event is not being provided. That patent is incorporated by reference in its entirety herein.

Similar to, but not the same as a template would be for the random number generator to use a single player position as a primary position for determining which number-ties apply to all hands. For example, the third player position may be the focus of a random number generator, and when one of the random numbers (e.g., 4) is selected for that third player position, player positions to the left or right of the third player's position may have numbers for the ties decrease in order (e.g., 3, 2, 1, 0, 9 . . . ) or increase in order (5, 6, 7, 8 . . . ). Thus, determination of a random value for one specific position will provide a determination (in ascending or descending order) for all other player positions.

Additionally, when one player position tie-number is selected, random templates may be selected for determining all other player position tie numbers. Thus, if the third player position (counting left to right from the last position on the table with eight player positions on the table) received a random selection of a tie value of 2, any template fitting the pattern of a, b, c, d, e, 2, g and h, wherein a, b, c, d, e, g and h are exclusively selected from the group consisting of 1, 3, 4, 5, 6, 7, 8, 9 and 0) may be imposed on the table for positioning of individual and collective player position tie-values.

It is felt that numbers should be displayed at each player position, whether or not the side bet wager is placed, as this can influence a player to later make the wager when that player sees how many winning outcomes on the wager that position will have missed because of failure to make the side bet wager. Alternatively, only player positions where the side bet wager has been made may be provided with the display of a random number to facilitate dealer/banker resolution of wagers and remove the need for all player positions to be examined for the winning outcome, but rather only player positions having made the wager with the symbol illuminated for the player position tie value.

The description that the secondary random event indicators (indicating the tie-values) are displayed “at each hand” does not require that the indicators be physically located at each player position. Rather, any system that indicates visually to the player that various values are independently provided at each player position may be provided by a screen behind the banker, showing the tie values at each player position may be used, as well as any other visual display system that can provide at least displays of tie-values at each player position to that player position.

The random event outcome indicator comprises a random number generator generally provides equally weighted distinct indications on individual displays at each of the at least two player positions of single digit point counts selected from the group consisting of 0, 1, 2, 3, 4, 5, 6, 7, 8, and 9, and/or the random event outcome indicator has a random number generator that provides equally weighted distinct indications on a single display panel visible to each of the at least two player positions of single digit point counts selected from the group consisting of 1, 2, 3, 4, 5, 6, 7, 8, and 9 or 0, 1, 2, 3, 4, 5, 6, 7, 8, and 9 that are randomly generated to each individual one of the at least two player positions without repetition of any of the single digit point counts.

By using the display system for ties at individual player positions, the method may use the second wager as a progressive jackpot wager.

A system for enabling a method of executing a game of baccarat with a side bet event. The game of baccarat may include a player hand of playing cards in competition with a banker hand of playing cards. A player hand position and a banker hand position receive playing cards from at least one randomized deck of 52 playing cards. The system may include:

the system including a gaming table with at least two distinct player positions at the gaming table;

the gaming table having positions thereon for placing an initial wager from at least one of at least two player positions at the gaming table on the game of baccarat;

the gaming table having positions thereon for placing a second wager on a side bet event from at least one of at least two player positions at the gaming table on the game of baccarat resolved by using final playing cards dealt to the player hand position and final playing cards dealt to the banker hand position;

each of the at least two player positions has a secondary random outcome indicator display;

the gaming table associated with a random event generator providing distinct random event outcome indicators to the secondary random outcome indicator displays at each of the at least two player positions; and each distinct random event outcome indicator representing a single digit number value selected from the group consisting of 0, 1, 2, 3, 4, 5, 6, 7, 8 and 9.

The system may enable the random event outcome indicator comprises a random number generator that provides equally weighted distinct indications on a single display panel visible to each of the at least two player positions of single digit point counts selected from the group consisting of 1, 2, 3, 4, 5, 6, 7, 8, and 9 that are randomly generated to each individual one of the at least two player positions without repetition of any of the single digit point counts, or the random event outcome indicator comprises a random number generator that provides equally weighted distinct indications on a single display panel visible to each of the at least two player positions of single digit point counts selected from the group consisting of 0, 1, 2, 3, 4, 5, 6, 7, 8, and 9 that are randomly generated to each individual one of the at least two player positions without repetition of any of the single digit point counts. The system may enable the second wager as a progressive jackpot wager and there is an automated accounting system in communication with the positions on the gaming table for placing the second wager.

The general technology is for a Baccarat Progressive Game for all formats of Baccarat (Live, ETG, Virtual, Online, and Mobile apps) which Applicant refers to as the “GOLDEN TIE.”

A common problem with Baccarat Progressives is that since Baccarat is a community game, the combinations of cards in the hand that trigger a progressive jackpot do so for all of the players participating, and the players therefore have to split the progressive.

This progressive system enables there to be one unique progressive winner when a particular series of cards is dealt and there are 10 or fewer players participating in the progressive wager.

Before each new hand of baccarat is dealt, this progressive system randomly generates a number from 0 to 9 for each participating player (can display it on sign or anywhere on table etc . . . on player station or sign for ETG, mobile device or tablet or player station or table for virtual or online game . . . it doesn't matter where it is displayed).

If there are 10 or less players, each player position receives an equally weighted random number from 0 to 9 . . . no 2 players are assigned the same number. So for example if there are exactly 10 players participating in the progressive, each player will receive a number from 0 to 9 (no 2 players will have the same number.) In an alternate version each player can receive a randomly generated number from 0 to 9 and players might have the same randomly generated number. In an alternate version, each player at the table or playing the baccarat game (ETG, Virtual, Online) may be randomly assigned a number from 0 to 9 (Even if they are not participating in the progressive game).

If there are between 11-20 players participating in the progressive, then the first 10 player positions receive an equally weighted random number from 0-9 (no 2 players of the first group of 10 have the same number), and then the remaining 1 to 10 players are assigned an equally weighted number from 0-9 (no duplicates).

This process is repeated for each multiple of 10 players participating in the progressive game.

The progressive game is based on TIES occurring during the main game of Baccarat.

Specifically the pay tables described below WIN when 6 CARD TIES are dealt during the main game of Baccarat (The SIX cards represent 3 Banker Cards being dealt and 3 Player Cards being dealt according to the commonly accepted rules of Baccarat). This can alternatively be done with pay tables including one or more of 4 card ties and 5 card ties in addition to 6 card ties.

The Pay Tables illustrate some examples of different conditions to win and some sample pay outs when that condition is won. The game is preferably played with ONLY six card counts used in the outcome, but variants may be used where only 4-card ties are used, only 5-card ties are used, or any combination of 4-card, 5-card and 6-card (the maximum cards allowable in baccarat) ties may be used, varying the paytable.

Some of the pay lines, and in Particular the Progressive Jackpot, are won when at a minimum a six card tie is dealt and the point total of the tie (according to the common scoring system of baccarat) matches the Number (0-9) that is generated and assigned to the participating progressive player.

GOLDEN TIE ™ PROGRESSIVE SAMPLE 1

| HAND | COMB | PROB | Pay Table | Return |
|---|---|---|---|---|
| 6 CARD TIE-SUITED + GOLD # | 14,303,277,327 | 0.00000286 | 100% | |
| 6 CARD TIE-SUITED | 128,729,495,943 | 0.00002575 | 1000 for 1 | 0.025754 |
| 6 CARD TIE-COLORED + GOLD# | 478,597,186,296 | 0.00009575 | 500 for 1 | 0.047875 |
| 6 CARD TIE-COLORED | 4,307,374,676,663 | 0.00086175 | 100 for 1 | 0.086175 |
| 6 CARD TIE + GOLD # | 15,866,942,169,312 | 0.00317441 | 50 for 1 | 0.158720 |
| 6 CARD TIE-ANY | 142,802,479,523,803 | 0.02856965 | 10 for 1 | 0.285696 |
| Total: | 4,998,398,275,503,360 | 0.03273017 | | |

GOLDEN TIE ™ PROGRESSIVE SAMPLE 2

| HAND | COMB | PROB | Pay Table | Return |
|---|---|---|---|---|
| 6 CARD TIE-GOLD # + SUITED | 14,303,277,327 | 0.00000286 | 100% | |
| 6 CARD TIE-SUITED | 128,729,495,943 | 0.00002575 | 1000 for 1 | 0.025754 |
| 6 CARD TIE-GOLD # + COLORED | 478,597,186,296 | 0.00009575 | 500 for 1 | 0.047875 |
| 6 CARD TIE-COLORED | 4,307,374,676,663 | 0.00086175 | 200 for 1 | 0.172350 |
| 6 CARD TIE-GOLD # | 15,866,942,169,312 | 0.00317441 | 50 for 1 | 0.158720 |
| 6 CARD TIE-ANY | 142,802,479,523,803 | 0.02856965 | 5 for 1 | 0.142848 |
| Total: | 4,998,398,275,503,360 | 0.03273017 | | |

GOLDEN TIE ™ PROGRESSIVE SAMPLE 3

| HAND | COMB | PROB | Pay Table | Return |
|---|---|---|---|---|
| 6 CARD TIE-GOLD # + DIAMONDS | 3,575,819,332 | 0.00000072 | 100% | |
| 6 CARD TIE-GOLD # + SUITED | 10,727,457,995 | 0.00000215 | 10% | |
| 6 CARD TIE-SUITED | 128,729,495,943 | 0.00002575 | 750 for 1 | 0.019316 |
| 6 CARD TIE-GOLD # + COLORED | 478,597,186,296 | 0.00009575 | 500 for 1 | 0.047875 |
| 6 CARD TIE-COLORED | 4,307,374,676,663 | 0.00086175 | 200 for 1 | 0.172350 |
| 6 CARD TIE-GOLD # | 15,866,942,169,312 | 0.00317441 | 50 for 1 | 0.158720 |
| 6 CARD TIE-ANY | 142,802,479,523,803 | 0.02856965 | 5 for 1 | 0.142848 |
| Total: | 4,998,398,275,503,360 | 0.03273017 | | |

GOLDEN TIE ™ PROGRESSIVE SAMPLE 4

| HAND | COMB | PROB | Pay Table | Return |
|---|---|---|---|---|
| 6 CARD TIE-GOLD # + SUITED | 14,303,277,327 | 0.00000286 | 100% | |
| 6 CARD TIE-SUITED | 128,729,495,943 | 0.00002575 | 1000 for 1 | 0.025754 |
| 6 CARD TIE-GOLD # + COLORED | 478,597,186,296 | 0.00009575 | 500 for 1 | 0.047875 |
| 6 CARD TIE-COLORED | 4,307,374,676,663 | 0.00086175 | 100 for 1 | 0.086175 |
| ANY TIE-GOLD # | 44,055,348,434,892 | 0.00881389 | 25 for 1 | 0.220347 |
| ANY TIE | 396,498,135,914,026 | 0.07932504 | 3 for 1 | 0.237975 |
| Total: | 4,998,398,275,503,360 | 0.08912505 | | |

GOLDEN TIE ™ SIDE BET SAMPLE

| HAND | COMB | PROB | Pay Table | Return |
|---|---|---|---|---|
| ANY TIE-GOLD # + SUITED | 329,872,052,163 | 0.00006600 | 1000 | 0.065996 |
| ANY TIE-SUITED | 2,968,848,469,464 | 0.00059396 | 200 | 0.118792 |
| ANY TIE-GOLD # + COLORED | 3,177,522,160,267 | 0.00063571 | 100 | 0.063571 |
| ANY TIE-COLORED | 28,597,699,442,405 | 0.00572137 | 50 | 0.286069 |
| ANY TIE-GOLD # | 44,055,348,434,892 | 0.00881389 | 10 | 0.088139 |
| ANY TIE | 396,498,135,914,026 | 0.07932504 | 3 | 0.237975 |
| NOTHING | 4,522,770,849,030,140 | 0.90484403 | −1 | (0.904844) |
| Total: | 4,998,398,275,503,360 | 1.00000000 | EDGE: | (0.044303) |

The above paytables are example of paytables that may be used in the practice of the present technology and are not intended to limit the scope of the generic invention described herein.

As noted above, the individual player numbers for the progressive side bet event may be distributed by a random number generator to individual player positions. In some jurisdictions, especially on physical playing card games, secondary random number generators are not allowed. It is further desirable to enable fair and equitable execution of the underlying progressive event without a secondary random event generator. This can be done by a variable and equitable distribution of the individual numbers. For simplicity, this is referred to as “pre-assignment” of Golden Tie™ target values.

Pre-assignment may be accomplished in numerous different non-random ways. For example, each position at a gaming table may have an indicator element able to identify a distinct single target number (from 0 through 9). The target numbers may be indicated by any format of visual display, including video, panel or other electrical displays (e.g., LED, liquid crystal, CRT, flip pane; displays, etc.) that can be changed at individual player positions. For example, in a less preferred embodiment the individual player positions at each table may have a printed or selectable number (e.g., with a lammer or player-selected display at each position).

A first player would then have the opportunity to select a ‘favorite’ number. He could keep that number as long as he/she is the only player, or receive a number as the first player, and subsequent player receive sequential numbers, and at the beginning of each hand the numbers would be passed along, number “1” passing to number “2” so that number “2” would get the first choice of numbers. The individual players each get an opportunity for each available target number as the game progresses.

Another method of pre-assignment would be for each position to have the visual display, with each number displayed in a fixed order. The order would progressively change at the beginning of each hand. The same number will never be assigned to more than one player duringt a single round of play of the underlying baccarat game. As there are ten available target numbers (0, 1, 2, 3, . . . 9), and there are typically only 5, 6 or 7 positions at each gaming table, 5, 4 or 3 target numbers, respectively, would not ordinarily be available during play of a is round. This can be addressed in a number of ways, such as eliminating 5, 4 or 3 target numbers, respectively, on each round. This can be done by completely eliminating some numbers (such as 0, 1, 2, 3 and/or 4) or by masking or excluding the 5, 4 or 3 numbers on each round. For example, in a first round, only individual numbers at six player positions of 0, 1, 2, 3, 4 and 5 would be shown. On a next round, only numbers 1, 2, 3, 4, 5 and 6 would be shown. On a further next round, only numbers 2, 3, 4, 5, 6 and 7 would be shown, until 4, 5, 6, 7, 8 and 9 are shown, the subsequent round reverting to 0, 1, 2, 3, 4 and 5. As not only the numbers change, but the position of each number shifts from player to player, there is an equal and fair distribution of all numbers to each player. The system of this paragraph is defined as “floating pre-assignment” as the numbers are pre-assigned for each round and float from player to player on each round. There should not be more than the same number of target numbers displayed as there are player positions (not necessarily players) at the gaming table.

It is possible for multiple numbers to be shown at each player position on the display screens, so that all target numbers are available during each round, although this complicates the probabilities and payouts. Again avoiding randomness, there may be two displays at each player position. One set of 5, 6 or 7 numbers may float (for example) left to right on one set of displays, and the remaining 4, 3 or 2 (respective) numbers may float in an antiparallel direction (e.g., right to left). In this manner, each player position will eventually receive each number and at various times multiple numbers.

Although a preferred system for practice of the technology is a felt-type game, with physical playing cards or electronic playing cards used on a typical playing card gaming table structure, the system may be used in purely electronic gaming tables, multiplayer console formats, video electronic gaming formats, on internet gaming play, through hand-held devices and the like. Enablement of these formats for playing card games is known in the art with commercial and disclosed systems available for transposing the physical table game system into these electronic wagering formats. Such variations in format are disclosed, for example, in US Published Application Document No. 20070298854 (DUNN), which is incorporated herein by reference.

The system may have all ties (0-9) available, or exclude one or more specific tie-numbers, such as excluding tie-4s in certain markets where the number four (4) is felt to be unlucky. Any combination of numbers between 0-9 may be used and any numbers excluded.

Other variants and modifications are within the generic scope of the present invention and are within the scope of the appended claims of this Application.

Wagers may be placed by physical placement of tokens or chips on wagering positions, electronic wagering input can be effected with established value on a player-input wagering control, and/or combinations of these. Especially for the side bet or progressive wager, a physical electronic wagering input control can be embedded in the table, with the player exercising control to identify the amount of the wager placed as the second wager, the side wager or the progressive wager. Such electronic player control inputs may also be used for the underlying blackjack wagers, especially on electronic format multi-player platforms, as are known in the art, such as in U.S. Pat. No. 9,530,279 (Smith) which is incorporated herein in its entirety, especially for its disclosure of gaming apparatus that can be used for the underlying game and game structure, to which the secondary event generator of the present technology (random or not) can be added. This Smith Patent is incorporated herein by reference in its entirety.

What is claimed:

1. A method of executing a game of baccarat with a side bet event, the game of baccarat comprising a player hand of playing cards in competition with a banker hand of playing cards, a player hand position and a banker hand position receiving playing cards from at least one randomized deck of 52 playing cards, the method comprising:
placing of an initial wager from at least one player position of at least two player positions at a gaming table on the game of baccarat;
the at least one player position placing a second wager on a side bet event resolved by using final playing cards dealt to the player hand position and final playing cards dealt to the banker hand position;
providing each of the at least two player positions with a secondary pre-assigned, non-random outcome indicator display;
the non-random outcome indicator display providing distinct pre-assigned indicators to the displays at each of the at least two player positions;
each distinct non-random event outcome indicator representing a single digit number value selected from the group consisting of 0, 1, 2, 3, 4, 5, 6, 7, 8 and 9;
at the conclusion of providing the final hands of playing cards to the player hand position and the banker hand position:
resolving the initial wager according to standard rules of baccarat; and
resolving the second wager at the at least one player position as a highest winning outcome when a single digit point count according to rules of baccarat in the final banker hand equals a single digit point count according to rules of baccarat in the final player hand and the single digit number value at one of the at least two player positions represented by the distinct non-random outcome indicator display is also equal to the single digit point count according to rules of baccarat in the final player and banker hands.

2. The method of claim 1 wherein the non-random outcome indicator display comprises a display that provides equally weighted distinct pre-assigned indications on individual displays at each of the at least two player positions of single digit point counts selected from the group consisting of 1, 2, 3, 4, 5, 6, 7, 8, and 9.

3. The method of claim 1 wherein the non-random outcome indicator display comprises a display that provides equally weighted distinct pre-assigned indications on individual displays at each of the at least two player positions of single digit point counts selected from the group consisting of 0, 1, 2, 3, 4, 5, 6, 7, 8, and 9.

4. The method of claim 1 wherein the non-random outcome indicator display comprises a display that provides equally weighted distinct indications on a single display panel visible to each of the at least two player positions of single digit point counts selected from the group consisting of 1, 2, 3, 4, 5, 6, 7, 8, and 9 that are non-randomly generated to each individual one of the at least two player positions without repetition of any of the single digit point counts.

5. The method of claim 1 wherein the non-random outcome indicator display comprises a display that provides equally weighted distinct indications on a single display panel visible to each of the at least two player positions of single digit point counts selected from the group consisting of 0, 1, 2, 3, 4, 5, 6, 7, 8, and 9 that are non-randomly generated to each individual one of the at least two player positions without repetition of any of the single digit point counts.

6. The method of claim 1 wherein the second wager comprises a progressive jackpot wager.

7. The method of claim 2 wherein the second wager comprises a progressive jackpot wager.

8. The method of claim 3 wherein the second wager comprises a progressive jackpot wager.

9. The method of claim 4 wherein the second wager comprises a progressive jackpot wager.

10. A system for enabling a method of executing a game of baccarat with a side bet event, the game of baccarat comprising a player hand of playing cards in competition with a banker hand of playing cards, a player hand position and a banker hand position receiving playing cards from at least one randomized deck of 52 playing cards, the method comprising:
the system including a gaming table with at least two distinct player positions at the gaming table;
the gaming table having positions thereon for placing an initial wager from at least one of at least two player positions at the gaming table on the game of baccarat;
the gaming table having positions thereon for placing a second wager on a side bet event from at least one of at least two player positions at the gaming table on the game of baccarat resolved by using final playing cards dealt to the player hand position and final playing cards dealt to the banker hand position;each of the at least two player positions has a non-random outcome indicator display comprising a visual display;
the gaming table associated with a non-random event generator providing distinct non-random event outcome indicators to the non-random outcome indicator displays at each of the at least two player positions; and
each distinct random event outcome indicator representing a single digit number value selected from the group consisting of 0, 1, 2, 3, 4, 5, 6, 7, 8 and 9.

11. The system of claim 10 wherein the non-random outcome indicator display provides equally weighted distinct indications on individual displays at each of the at least two player positions of single digit point counts selected from the group consisting of 1, 2, 3, 4, 5, 6, 7, 8, and 9.

12. The system of claim 10 wherein the non-random outcome indicator display comprises a display provides equally weighted distinct indications on individual displays at each of the at least two player positions of single digit point counts selected from the group consisting of 0, 1, 2, 3, 4, 5, 6, 7, 8, and 9.

13. The system of claim 10 wherein the non-random outcome indicator display provides equally weighted distinct indications on a single display panel visible to each of the at least two player positions of single digit point counts selected from the group consisting of 1, 2, 3, 4, 5, 6, 7, 8, and 9 that are randomly generated to each individual one of the at least two player positions without repetition of any of the single digit point counts.

14. The system of claim 10 wherein the non-random outcome indicator display provides equally weighted distinct indications on a single display panel visible to each of the at least two player positions of single digit point counts selected from the group consisting of 0, 1, 2, 3, 4, 5, 6, 7, 8, and 9 that are randomly generated to each individual one of the at least two player positions without repetition of any of the single digit point counts.

15. The system of claim 10 wherein the second wager comprises a progressive jackpot wager and there is an automated accounting system in communication with the positions on the gaming table for placing the second wager and uses floating pre-assignment of the equally weighted distinct indications.

16. The system of claim 11 wherein the second wager comprises a progressive jackpot wager and there is an automated accounting system in communication with the positions on the gaming table for placing the second wager.

17. The system of claim 12 wherein the second wager comprises a progressive jackpot wager and there is an automated accounting system in communication with the positions on the gaming table for placing the second wager.

18. The system of claim 13 wherein the second wager comprises a progressive jackpot wager and there is an automated accounting system in communication with the positions on the gaming table for placing the second wager.

19. The system of claim 14 wherein the second wager comprises a progressive jackpot wager and there is an automated accounting system in communication with the positions on the gaming table for placing the second wager.

20. A method of executing a game of baccarat with a side bet event, the game of baccarat comprising a player hand of playing cards in competition with a banker hand of playing cards, a player hand position and a banker hand position receiving playing cards from at least one randomized deck of 52 playing cards, the method comprising:
placing of an initial wager from at least one player position of at least two player positions at a gaming table on the game of baccarat;
the at least one player position placing a second wager on a side bet event resolved by using final playing cards dealt to the player hand position and final playing cards dealt to the banker hand position;
providing each of the at least two player positions with a secondary pre-assigned, outcome indicator display;
the outcome indicator display providing distinct pre-assigned indicators to the displays at each of the at least two player positions;
each distinct event outcome indicator representing a different single digit number value selected from the group consisting of 0, 1, 2, 3, 4, 5, 6, 7, 8 and 9;
at the conclusion of providing the final hands of playing cards to the player hand position and the banker hand position:
resolving the initial wager according to standard rules of baccarat; and
resolving the second wager at the at least one player position as a highest winning outcome when a single digit point count according to rules of baccarat in the final banker hand equals a single digit point count according to rules of baccarat in the final player hand and the single digit number value at one of the at least two player positions represented by the distinct non-random outcome indicator display is also equal to the single digit point count according to rules of baccarat in the final player and banker hands, wherein the second wager comprises a progressive jackpot wager.
